(19) United States
(12) Patent Application Publication
(10) Pub. No.: US 2021/0201700 A1
(43) Pub. Date: Jul. 1, 2021

(54) SURGICAL TRAINING MODELS, SYSTEMS, AND METHODS

(71) Applicant: Boston Scientific Scimed, Inc., Maple Grove, MN (US)

(72) Inventor: Yasuhisa ABE, Tokyo (JP)

(73) Assignee: Boston Scientific Scimed, Inc., Maple Grove, MN (US)

(21) Appl. No.: 17/057,812

(22) PCT Filed: May 30, 2019
(86) PCT No.: PCT/US2019/034587

§ 371 Date: Nov. 23, 2020

Related U.S. Application Data
(60) Provisional application No. 62/678,353, filed on May 31, 2018.

(51) Int. Cl. G09B 23/28

(52) U.S. Cl. CPC G09B 23/285

(57) ABSTRACT

According to one aspect of the present disclosure, a medical training apparatus may include a stomach model, a duodenum model, and a first coupler. The first coupler may be releasably coupling the stomach model to the duodenum model in a first orientation of the duodenum model relative to the stomach model and in a second orientation of the duodenum model relative to the stomach model.

### TECHNICAL FIELD

The present disclosure relates generally to surgical training systems, surgical training models, and related methods. More particularly, the present disclosure relates to devices and methods used when training doctors to manipulate endoscopes.

### BACKGROUND

To properly teach endoscope procedures, it is desirable to use live animals or training apparatuses that mimic live organs. The use of live animals typically involves sedating the animal and sacrificing the animal after the training procedure is completed, which is costly, results in loss of life, and therefore limits the opportunities to train and develop new procedures. Also, transporting biological materials, such as donated organs, is limited by the life of the biological tissue, which often spoils rapidly, and animal biological material may not accurately mimic human anatomy.

Current designs of synthetic training systems designed to mimic human organs are usually less realistic than biological tissue. Also, current synthetic training systems often are difficult to transport. There is a need for an endoscopy training system that may address one or more of these or other issues.

### SUMMARY

Embodiments of the present disclosure relate to, among other things, a duodenum model, an organ model support, and a training device that simulates a feel of a living human body when training a health care provider to manipulate an endoscope, duodenoscope, colonoscope, broncoscope, or related medical device. Each of the embodiments disclosed herein may include one or more of the features described in connection with any of the other disclosed embodiments.

One aspect of the present disclosure is an organ model support configured to support one or more organ models. In some examples, the organ model support is provided with an accommodation pit including a pit wall that is curved in conformance with shapes of the one or more organ models. The accommodation pit may be formed from an elastic material.

Another aspect of the present disclosure is a duodenum model including a bile duct, a pancreatic duct, a tubular main body to which the bile duct and the pancreatic duct are connected, and a duodenal papilla projecting into the main body. The main body, the bile duct, the pancreatic duct, and the duodenal papilla may be formed integrally with one another.

A further aspect of the present disclosure is a training device for training a health care provider to manipulate an endoscope or other medical device. The training device may include one or more organ models and the organ model support described above.

According to one aspect of the present disclosure, a medical training apparatus may include a stomach model, a duodenum model, and a first coupler. The first coupler may be releasably coupling the stomach model to the duodenum model in a first orientation of the duodenum model relative to the stomach model and in a second orientation of the duodenum model relative to the stomach model.

In other aspects of the present disclosure, the medical training apparatus may include one or more of the features below. The medical training apparatus may further include an esophagus model and a second coupler. The second coupler may releasably couple the esophagus model to the stomach model. A partition diaphragm may be positioned between the esophagus model and the stomach model. The duodenum model may include an end wall defining a pyloric orifice. The duodenum model may include a main body, a bile duct, a pancreatic duct, and a duodenal papilla projecting into the main body. The duodenal papilla may have a first position relative to the stomach model when the duodenum model is in a first orientation and may have a second position relative to the stomach model when the duodenum model is in a second orientation. The main body, the bile duct, the pancreatic duct, and the duodenal papilla may be integrally formed. An organ model support may include an accommodation pit. The accommodation pit may be defined by a wall that is curved to conform with outer surfaces of the stomach model and the duodenum model, and the accommodation pit may comprise elastic material. The stomach model and the duodenum model may be positioned within the accommodation pit of the organ model support. The accommodation pit may include a first engagement recess, and a first coupler may be positioned in the first engagement recess. The first engagement recess may be sized to permit movement of a first coupler therein. The first coupler may be positioned in the first engagement recess so that it moves in the first engagement recess when an endoscope applies a force to the duodenum model. A portion of the organ model support may overlie a portion of the duodenum model. The medical training apparatus may further include a second duodenum model, and the first coupler may be configured to permit removal of the duodenum model from the stomach model and coupling of the second duodenum model to the stomach model. The first coupler may include first and second engagement rings and a hinge pivotally connecting the first engagement ring to the second engagement ring. An end of the stomach model may connect to the first engagement ring and an end of the duodenum model may connect to the second engagement ring. The hinge may permit the first coupler to close, aligning the ends of the stomach and duodenum models. The end of the stomach model may include a flange, the end of the duodenum model may include a flange, and the flange of the end of the stomach model and the flange of the end of the duodenum model may be positioned between the first and second engagement rings.

In other aspects of the present disclosure, a medical training apparatus may include an esophagus model, a stomach model, a duodenum model, a first coupler releasably coupling the stomach model to the duodenum model, a second coupler releasably coupling the esophagus model to the stomach model; and an organ model support. The organ model support may include an accommodation pit for containing the esophagus model, the stomach model, and the duodenum model. The accommodation pit may be defined by a wall that is curved to conform with the outer surfaces of the esophagus model, the stomach model, and the duodenum model.

In other aspects of the present disclosure, the medical training apparatus may include one or more of the features below. The first coupler may include a projection (such as a flange), the second coupler may include a projection, and the organ model support may include a first engagement recess and a second engagement recess. The first engagement recess may be a recess in the pit wall and may be configured to receive the projection of a first coupler. The second engagement recess may be a recess in the pit wall and configured to receive the projection of a second coupler. The accommodation pit may include a first region and a second region that each allows for arrangement of the duodenum model, and the duodenum model may differ in orientation relative to the stomach model when arranged in a first region and when arranged in a second region. The duodenum model may have a first position relative to the stomach model when the duodenum model is in a first orientation and may have a second position relative to the stomach model when the duodenum model is in a second orientation. The position of the duodenum model in the first orientation may be rotated about the first coupler relative to the second orientation.

In other aspects, a duodenum model may include a bile duct, a pancreatic duct, and a tubular main body to which the bile duct and the pancreatic duct are connected. The main body may include a first end with an inlet that allows for entrance of an endoscope and a second end at an opposite side of the first end. The duodenum model may also include a duodenal papilla projecting into the main body and tilted toward the second end in the main body. The main body, the bile duct, the pancreatic duct, and the duodenal papilla may be formed integrally with one another.

In other aspects, the duodenum model may include one or more of the features below. The main body may include an annular portion surrounding a portion where the bile duct and the pancreatic duct are connected to the main body. The annular portion may be thicker than other portions of the main body. The main body may include an end wall closing the first end; and the end wall may include a pyloric orifice extending through the end wall.

Both the foregoing general description and the following detailed description are exemplary and explanatory only and are not restrictive of the features, as claimed. As used herein, the terms “comprises,” “comprising,” “including,” “having,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Additionally, the term “exemplary” is used herein in the sense of “example,” rather than “ideal.” As used herein, the terms “about,” “substantially,” and “approximately,” indicate a range of values within +/−5% of the stated value.

### BRIEF DESCRIPTION OF THE DRAWINGS

The accompanying drawings, which are incorporated in and constitute a part of this specification, illustrate various exemplary embodiments and together with the description, serve to explain the principles of the disclosure.

FIG. 1 is an exploded perspective view of an exemplary training device according to one embodiment;

FIG. 2 is a plan view of the exemplary training device of FIG. 1;

FIG. 3 is a plan view of an exemplary organ model support according to one embodiment;

FIG. 4 is a horizontal cross-sectional view of an exemplary duodenum model according to one embodiment;

FIG. 5 is a vertical cross-sectional view of the exemplary duodenum model shown in FIG. 4;

FIG. 6 is a plan view showing part of the exemplary training device of FIG. 1;

FIG. 7 is an image of the model duodenal papilla captured by an endoscope inserted in the exemplary duodenum model of FIG. 4; and

FIG. 8 is an image of the model duodenal papilla captured by an endoscope inserted in the exemplary duodenum model in FIG. 7 when the orientation of the exemplary duodenum model differs from that of the state shown in FIG. 7.

### DETAILED DESCRIPTION

Examples of duodenum models, organ model supports, and training devices according to the present disclosure will now be described with reference to the drawings.

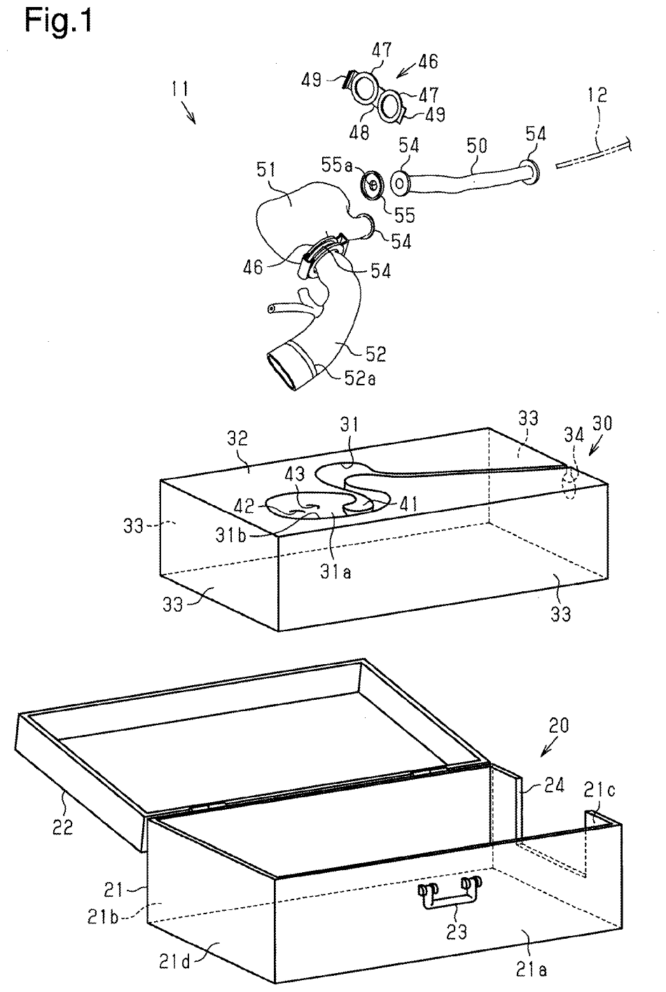

As shown in FIG. 1, a training device 11 that may be used to train a person, for example a health care service provider such as a doctor, to manipulate an endoscope or other medical device includes one or more organ models, an organ model support 30, and a case 20 accommodating the organ model support 30. The one or more organ models may include, for example, an esophagus model 50, a stomach model 51, and a duodenum model 52.

The case 20 may include a box 21 that accommodates the organ model support 30. The box 21 may include four side walls 21a, 21b, 21c, and 21d and a bottom wall intersecting the four side walls 21a, 21b, 21c, and 21d. The case 20 may further include a lid 22 that covers the opening of the box 21 and a handle 23 attached to the side wall 21a of the box 21. The training device 11 may be easily carried by closing the opening of the box 21 with the lid 22 and holding the handle 23. The box 21 may include an insertion portion 24 through which an endoscope 12 or other medical device is inserted. The insertion portion 24 may be formed by, for example, cutting out part of the side wall 21c of the box 21.

The organ model support 30 may be formed from an elastic material. One example of an elastic material forming the organ model support 30 is urethane resin. The organ model support 30 may be formed integrally from the same material. The organ model support 30 of the present embodiment may be an elastic body that is substantially a rectangular parallelepiped.

The organ model support 30 may include an accommodation pit 31 accommodating the one or more organ models, an opening surface 32 where the accommodation pit 31 opens (surface 32 defines an upper opening 31b of pit 31), four side surfaces 33 intersecting the opening surface 32, and a bottom surface located at a side opposite to the opening surface 32. The accommodation pit 31 may include a continuous pit wall 31a and a continuous opening 31b. The pit wall 31a may be curved to conform with the shapes, that is, the three-dimensional shapes, of the organ models 50, 51, and 52.

One of the four side surfaces 33 may include a projection opening 34. The organ model into which the endoscope 12 may be first inserted, for example, the esophagus model 50, may be partially projected out of the accommodation pit 31 through the projection opening 34. The interior of the accommodation pit 31 may be in communication with the exterior through the projection opening 34. The projection opening 34 may be located at a position overlapping the insertion portion 24 of the case 20. The projection opening 34 may be a cutout part connected to the opening 31b of the accommodation pit 31.

The esophagus model 50, the stomach model 51, and the duodenum model 52 may be formed from an elastic material. The esophagus model 50, the stomach model 51, and the duodenum model 52 may be formed from a material having higher flexibility than the organ model support 30. The esophagus model 50, the stomach model 51, and the duodenum model 52 may be formed from different materials.

The duodenum model 52 may be formed from a material that is softer and deformed more easily than the materials of the esophagus model 50, the stomach model 51, and the organ model support 30. One example of the material of the duodenum model 52 is polyvinyl alcohol. The duodenum model 52 may be stored, for example, in a state moisturized with saline. The duodenum model 52 may be moisturized to maintain a state that is close to the softness of a living body.

The esophagus model 50, the stomach model 51, and the duodenum model 52 may each have an inlet for the endoscope 12 and an outlet located at a side opposite to the inlet. The outlet of the esophagus model 50 may be connected to the inlet of the stomach model 51, and the outlet of the stomach model 51 may be connected to the inlet of the duodenum model 52.

The training device 11 may simulate a state in which a patient is lying in the prone or supine position when the box 21 is set with the opening surface 32 of the organ model support 30 directed upward. When a person uses the training device 11 to train endoscope or other medical device manipulations, the endoscope 12 (or other medical device) may be inserted through the insertion portion 24 of the case 20 into the inlet of the esophagus model 50.

When the training is completed, the lid 22 of the case 20 may be closed. The case 20 protects the elastic organ model support 30 when the training device 11 is not in use.

The training device 11 may include a coupler 46 that couples two organ models in a separable manner. For example, the organ models 50, 51, and 52 may be coupled together by two couplers 46 and then accommodated in the accommodation pit 31 through the opening 31b. The organ models 50, 51, and 52 each may include one or two ends connected to another organ model. Such an end may include a flange 54 engaged with the coupler 46.

A partition diaphragm 55 may be located between the esophagus model 50 and the stomach model 51 and may include a cardia hole 55a simulating the cardia. The arrangement of the partition diaphragm 55 allows a doctor to practice manipulations for moving the endoscope 12 through the cardia in the human body. The partition diaphragm 55 may be held by the coupler 46 between the esophagus model 50 and the stomach model 51.

Each coupler 46 may include, for example, two engagement rings 47, a hinge 48 pivotally coupling the two engagement rings 47, and a hook 49 projecting from each engagement ring 47. The couplers 46 may have a higher rigidity than the organ models 50, 51, and 52 and the organ model support 30.

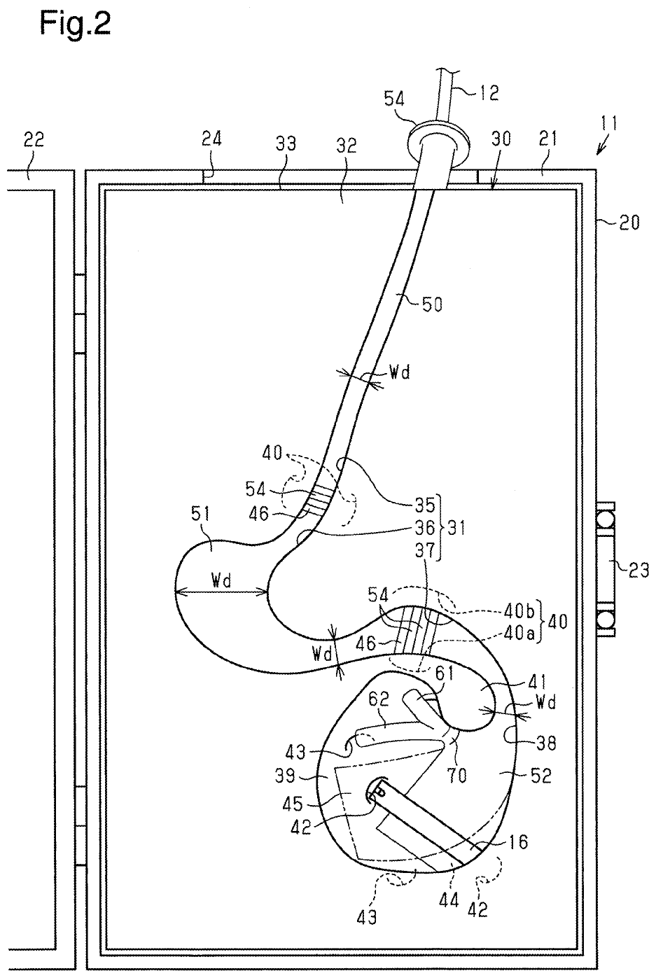

As shown in FIG. 2, the accommodation pit 31 of the organ model support 30 may include a first groove 35, a second groove 36, and a third groove 37. The first groove 35, the second groove 36, and the third groove 37 may be respectively formed in conformance with the three-dimensional shapes of the esophagus model 50, the stomach model 51, and the duodenum model 52. When the organ models 50, 51, and 52 are respectively located in the first groove 35, the second groove 36, and the third groove 37 in a state coupled together by the two couplers 46, the organ models 50, 51, and 52 may be entirely accommodated in the accommodation pit 31 without substantially projecting out of the opening surface 32.

The first groove 35, the second groove 36, and the third groove 37 each have dimensions, namely, a width Wd and a depth, that may differ in accordance with the dimensions of the esophagus model 50, the stomach model 51, and the duodenum model 52. For example, the second groove 36 that accommodates the stomach model 51 may include a portion that is deeper than the third groove 37, which may accommodate the duodenum model 52. The dimensions of the first groove 35, the second groove 36, and the third groove 37 may be larger than or slightly larger than the organ models 50, 51, and 52 that are respectively accommodated in the first groove 35, the second groove 36, and the third groove 37.

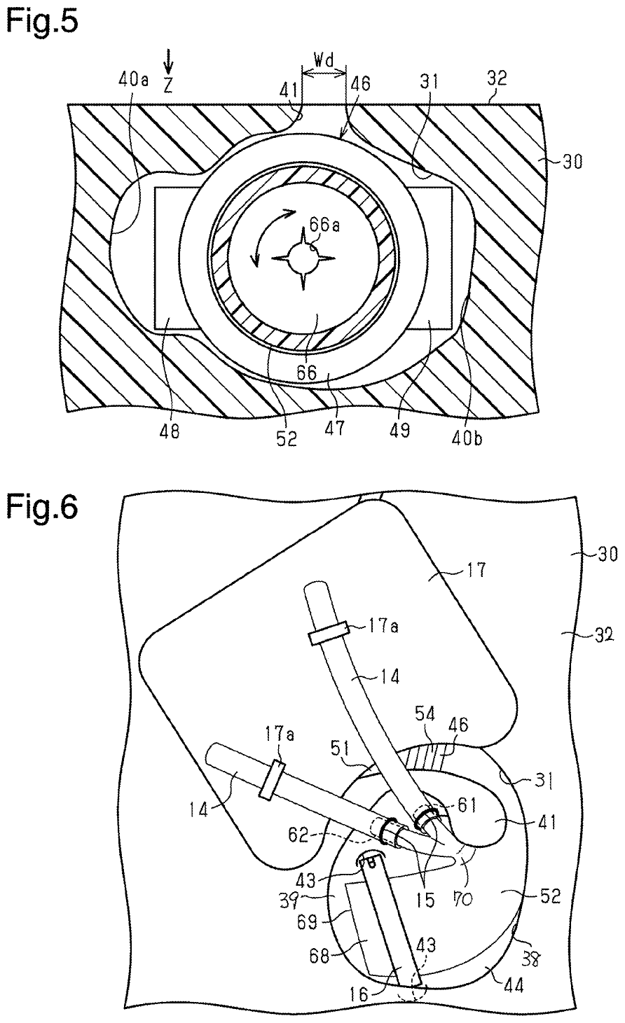

The width Wd of each of the first groove 35, the second groove 36, and the third groove 37 is the dimension taken in a direction orthogonal to both of the extending direction and the depth-wise direction (Z-direction in FIG. 5) of the corresponding first groove 35, second groove 36, and third groove 37. The extending directions of the grooves 35, 36, and 37 are the extending directions of the corresponding organ models 50, 51, and 52, which are tubular organs, taken along a longitudinal axis of the lumen of the organ model from inlet to outlet.

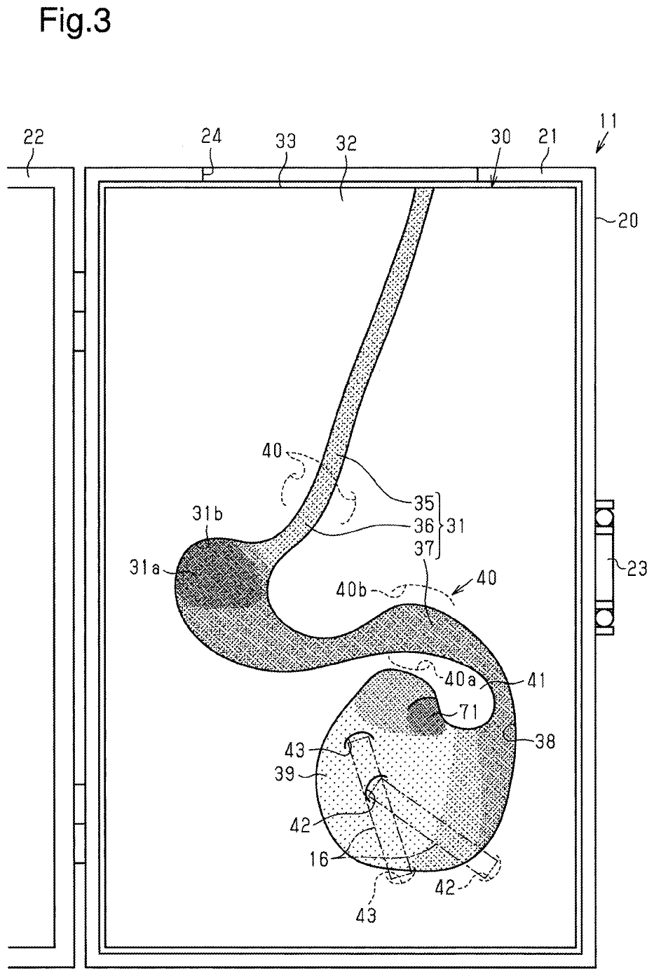

As shown in FIG. 3, the third groove 37 may include a curved groove portion 38 that extends in a curved manner from the second groove 36 and a widened portion 39 that widens toward the inner side (leftward in FIG. 3) from the curved groove portion 38. The maximum width inside each of the first groove 35, the second groove 36, and the curved groove portion 38 may be greater than the width at the corresponding opening in the opening surface 32.

The widened portion 39 may gradually shallow from one widthwise end (right end in FIG. 3) of the curved groove portion 38 toward the inner side (leftward in FIG. 3). The width of the widened portion 39 at the opening in the opening surface 32 may be greater than the maximum width inside the widened portion 39. In FIG. 3, the darker portions indicate deeper portions.

The accommodation pit 31 of the organ model support 30 may include engagement recesses 40 near the boundary of the first groove 35 and the second groove 36 and near the boundary of the second groove 36 and the third groove 37. The engagement recesses 40 may be portions of the pit wall 31a and smoothly continuous with other portions of the pit wall 31a.

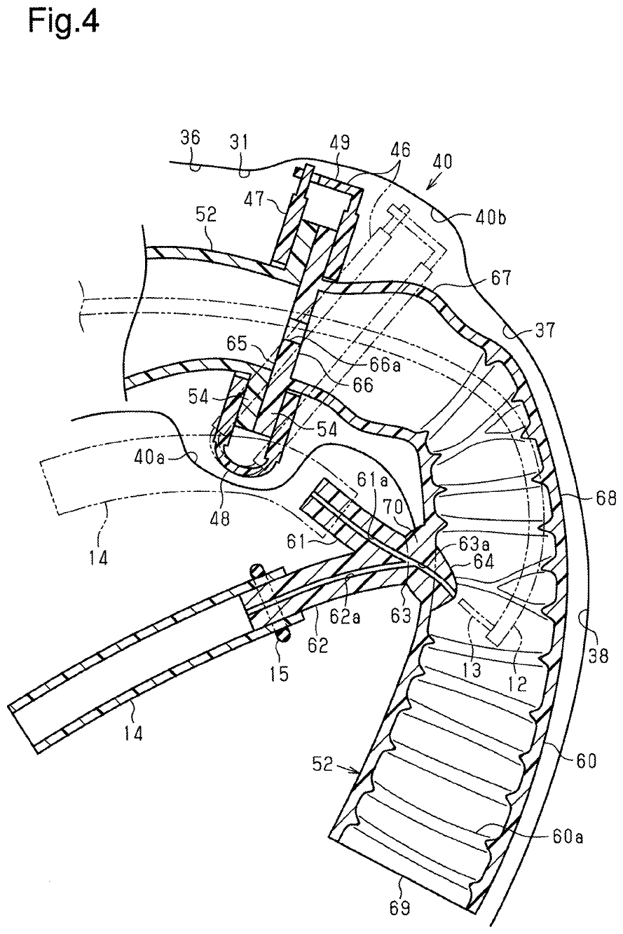

As shown in FIG. 4, each engagement recess 40 may be engaged with the corresponding coupler 46. Each engagement recess 40 may include two engagement recesses 40a and 40b that are recessed from two widthwise ends of the portion connecting the grooves 36 and 37. The first engagement recess 40a and the second engagement recess 40b may correspond to the two projections of the couplers 46, namely, the hinge 48 and the hooks 49. The first engagement recess 40a may be located at the inner side of the curved grooves 36 and 37, and the second engagement recess 40b may be located at the outer side of the grooves 36 and 37. The first engagement recess 40a may be recessed more deeply than the second engagement recess 40b, and the second engagement recess 40b may be longer than the first engagement recess 40a in a direction in which the grooves 36 and 37 extend.

When changing the advancing direction of the endoscope 12 or other medical device that has been inserted into the duodenum model 52, the endoscope 12 may come into contact with the inner wall of the duodenum model 52. Further, the duodenum model 52 pressed by the endoscope 12 may come into contact with the curved groove portion 38 of the accommodation pit 31. The duodenum model 52 and the curved groove portion 38 are elastically deformed when pressed by the endoscope 12 and apply a reaction force to the endoscope 12.

The duodenum model 52 may include a tubular main body 60, a bile duct 61, a pancreatic duct 62, and a duodenal papilla 64. The duodenal papilla 64 may simply be referred to as the papilla 64. The main body 60, the bile duct 61, the pancreatic duct 62, and the papilla 64 may be formed integrally.

The bile duct 61 may not include a portion connected to the gallbladder, and the pancreatic duct 62 may not include a portion connected to the pancreas. For example, the model may not include portions corresponding to a pancreas or a gall bladder. The bile duct 61 may include a lumen 61a, and the pancreatic duct 62 may include a lumen 62a. The lumens 61a and 62a converge at a portion connected to the main body 60. The portion where the bile duct 61 and the pancreatic duct 62 converge into a single duct is referred to as a connection duct 63.

A tube 14 may be connected to each of the bile duct 61 and the pancreatic duct 62. Each of the two tubes 14 may be coupled to the bile duct 61 or the pancreatic duct 62 by a fastener 15. The fastener 15 may be , for example, a rubber cord or a clip. The tubes 14 may be transparent.

The main body 60 may include a first end 65 connected to the stomach model 51, a second end 69 at an opposite side of the first end 65, and an end wall 66 closing the first end 65. The end wall 66 may include a pyloric orifice 66a that extends through the end wall 66. The pyloric orifice 66a may be the inlet to the duodenum model 52 for the endoscope 12 or other medical device. The pyloric orifice 66a may be formed by cutting slits in a cross-like manner around a circular hole (refer to FIG. 5). This simulates the feel of inserting a medical device into a human pylorus.

In another embodiment, the main body 60 may not have to include the end wall 66. In this case, a partition diaphragm like the partition diaphragm 55 (refer to FIG. 1) may be prepared with the pyloric orifice 66a and held by the coupler 46 between the stomach model 51 and the duodenum model 52. The second end 69 of the main body 60 may be closed or open.

The inner wall surface of the main body 60 may include a plurality of annular folds 60a. The main body 60 may include the end wall 66, a duodenal bulb 67 having an increased diameter relative to adjacent portions, and a descending part 68 of the duodenum in order from the first end 65 toward the second end 69. The main body 60 may further include the horizontal part of the duodenum and the ascending part of the duodenum that are joined with the descending part 68 of the duodenum.

The papilla 64 may be located in the descending part 68 of the duodenum projecting toward the inner side of the main body 60. The connection duct 63 may project from the outer surface of the main body 60 at the portion where the papilla 64 projects. The papilla 64 may include a communication hole 63a. The lumens 61a and 62a may be in communication with the inside of the main body 60 through the communication hole 63a.

The papilla 64 may be tilted in the main body 60 toward the second end 69. The connection duct 63 may be connected to the main body 60 at an angle corresponding to the papilla 64. The tilt angles of the papilla 64 and the connection duct 63 may be approximate to the tilt angles of the papilla and connection duct in the human body.

The main body 60 may include an annular portion 70 at a location where the connection duct 63 is connected to the main body 60. The annular portion 70 may be thicker than other portions of the main body 60. For example, the annular portion 70 may have a thickness in the range of about 5 mm to about 8 mm, and other portions of the main body 60 may have a thickness in the range of about 3 mm to about 5 mm. Further, the annular portion 70 may have a diameter of approximately 2 cm. The annular portion 70 may surround the communication hole 63a. The annular portion 70 may be conical.

As shown in FIG. 2, the organ model support 30 may include a projection 41 that projects over the duodenum model 52, when model 52 is in the accommodation pit 31. More specifically, a portion of the opening surface 32 may project over one or more organ models accommodated in the accommodation pit 31 to form the projection 41. The projection 41 may be formed so that the area occupying the opening surface 32 is greater at the distal portion than the proximal portion. The projection 41 may project from the widened portion 39 toward the curved groove portion 38 so as to sandwich the duodenum model 52 with the curved groove portion 38.

The distal portion of the projection 41 may hold the duodenum model 52, which is accommodated in the accommodation pit 31, at the portion between the duodenal bulb 67 and the connection duct 63. The projection 41 may have a thickness (dimension in depth-wise direction of accommodation pit 31) that is smaller than the length of the projection 41 projecting in the opening surface 32. Thus, the projection 41 keeps the duodenum model 52 in the third groove 37 without interfering with the elastic deformation of the duodenum model 52.

As shown in FIG. 5, in the depth-wise direction of the accommodation pit 31 (Z-direction in FIG. 5), the engagement recess 40a may be located below the proximal portion of the projection 41. This may hold the duodenum model 52 at three portions, namely, the projection 41 and the engagement recesses 40a and 40b. The three portions holding the duodenum model 52 each permit elastic deformation of the duodenum model 52. Thus, the endoscope 12 inserted into the duodenum model 52 may receive a reaction force that simulates the reaction force that would be received from the human body.

As shown in FIG. 2, the training device 11 may include a restraint 16 that holds the main body 60 of the duodenum model 52. The restraint 16 may be, for example, an elongated clip that holds the descending part 68 of the duodenum. The restraint 16 may have higher rigidity than the duodenum model 52 and the organ model support 30. The duodenum model 52 may include a mark 52a (refer to FIG. 1) indicating where to attach the restraint 16.

The accommodation pit 31 may include two engagement holes 42, each of which may be engaged with one of the two ends of the restraint 16. The restraint 16 may be a pin fitted into one of the engagement holes 42 to hold the duodenum model 52 in place.

The accommodation pit 31 of the organ model support 30 may include a first region 44 and a second region 45 that are each set to allow for arrangement of the duodenum model 52. In this case, the accommodation pit 31 may include first engagement holes 42 corresponding to the first region 44 and second engagement holes 43 corresponding to the second region 45. The orientation of the duodenum model 52 may differ when the duodenum model 52 is arranged in the first region 44 and when the duodenum model 52 is arranged in the second region 45. For example, the first region 44 may be located along the curved groove portion 38, and the second region 45 may be located along the widened portion 39 having a small depth-wise dimension.

The duodenum model 52 may further include a third region (not shown) and a fourth region (not shown) located between the first region 44 and the second region 45. The regions 44 and 45 may be different recesses shaped in conformance with the descending part 68 of the duodenum. Alternatively, the duodenum model 52 may be held by the restraint 16 anywhere in the widened portion 39. An accommodation region 71 (refer to FIG. 3) may be defined in the widened portion 39 between the projection 41 and the second region 45 to accommodate the bile duct 61 and the pancreatic duct 62 of the duodenum model 52.

When the restraint 16 is attached to the duodenum model 52 that is arranged in the first region 44, the restraint 16 may engage with the first engagement holes 42 to hold the duodenum model 52 in the first region 44 as shown by the solid lines in FIG. 2. When the restraint 16 is attached to the duodenum model 52 that is arranged in the second region 45, the restraint 16 may engage with the second engagement holes 43 to hold the duodenum model 52 in the second region 45 as shown in FIG. 6.

The walls of the engagement holes 42 and 43 may be formed from an elastic material. This allows the duodenum model 52 to elastically deform when pressed by the endoscope 12 even in a state in which the restraint 16 is attached. This simulates a feel of the human body when the endoscope 12 is inserted into the duodenum model 52.

The duodenum model 52 can be rotated relative to the stomach model 51 at the portion where the duodenum model 52 is connected to the stomach model 51 to change the projecting directions of the bile duct 61 and the pancreatic duct 62. Rotation may be facilitated when the duodenum model 52 and the stomach model 51 have ring-shaped end faces that are connected to each other. For example, after removal of the coupler 46, the duodenum model 52 may be rotated so that the bile duct 61 and the pancreatic duct 62 of the duodenum model 52 project out of the opening 31b. Then, the duodenum model 52 and the stomach model 51 may be connected again with the coupler 46.

For example, the duodenum model 52 may be rotated in the clockwise direction or the counterclockwise direction shown in FIG. 5 to change how the papilla 64 and the communication hole 63a look like when the endoscope 12 is inserted. Since the location of the duodenal papilla differs between individuals, by simulating different positions of the duodenal papilla, a doctor can be trained to perform a wide variety of manipulations.

The flanges 54 or the coupler 46 of the connected organ models 51 and 52 may include one or more marks to indicate the relative positions of the organ models 51 and 52. Examples of the marks include calibrations, stickers, notches, and projections. When relatively rotating the organ models 51 and 52 using the marks as references, the rotation amount can easily be checked when training a doctor to manipulate an endoscope or other medical device.

A plurality of duodenum models 52 may be prepared with the papilla 64 of each model 52 tilted differently. In this case, different duodenum models 52, each having a papilla 64 tilted differently from the papilla 64 of the other duodenum models 52, are connected to the stomach model 51. The tilt of the duodenal papilla differs between individuals. Thus, the duodenum models 52 may simulate the different tilts of the duodenal papilla and can be used to train a doctor to perform a wide variety of manipulations.

The operation of the duodenum model 52, the organ model support 30, and the training device 11 will now be described.

The training device 11 may be suitable for training a doctor to perform cannulation or endoscopic sphincterotomy (EST) that are techniques related with endoscopic retrograde cholangiopancreatography (ERCP).

The endoscope 12 may be moved through the esophagus, the cardia, and the stomach for insertion into the duodenum of the human body. In particular, during the process in which the endoscope 12 moves through the cardia and the stomach, the endoscope 12 needs to be advanced in various directions in conformance with the shapes of the cardia and the stomach. In this respect, the training device 11 may include the esophagus model 50, the cardia hole 55a, and the stomach model 51 to train a doctor to insert the endoscope 12 into the duodenum under an environment simulating the human body.

Substantially all of the organ models 50, 51, and 52 may be respectively accommodated in the grooves 35, 36, and 37. Thus, regardless of the angle at which the endoscope 12 comes into contact with the inner wall of the organ models 50, 51, or 52, a reaction force from the accommodation pit 31 may be applied to the endoscope 12. This simulates a feel of the human body when the endoscope 12 is inserted into the organ models 50, 51, and 52 during training.

An endoscope for the duodenum used in ERCP procedures generally includes an imaging device for backward-oblique viewing that captures images taken obliquely at the backward side with respect to the advancing direction. Further, in the duodenum of the human body, the duodenal papilla projects obliquely toward the large intestine (downward when patient is standing). Thus, when the endoscope 12 is inserted into the duodenum, the endoscope may be advanced beyond the papilla before searching for the opening of the papilla.

In this regard, the duodenal papilla 64 of the duodenum model 52 may extend obliquely toward the second end 69 in the main body 60. Thus, the communication hole 63a may simulate the view of the human body when the endoscope 12 is inserted into the duodenum model 52. For example, after advancing the endoscope 12 to the far side in the descending part 68 of the duodenum, the endoscope 12 may be drawn back to search for the papilla 64 and the communication hole 63a.

To train a person, such as a doctor, to manipulate an endoscope, when inserting a wire 13 into the communication hole 63a to incise the papilla 64, the wire 13 may be projected toward the papilla 64 (refer to FIG. 4) while viewing the images captured by the endoscope 12. If the wire 13 moves far away from the papilla 64, the wire 13 will be stuck into the thin portion of the main body 60, that is, around the annular portion 70. The annular portion 70 and the portion around the annular portion 70 may be exposed to the outside from the wide opening of the widened portion 39. Thus, sticking marks formed by the wire 13 would be visual and easy to find. Accordingly, the training results can be easily checked.

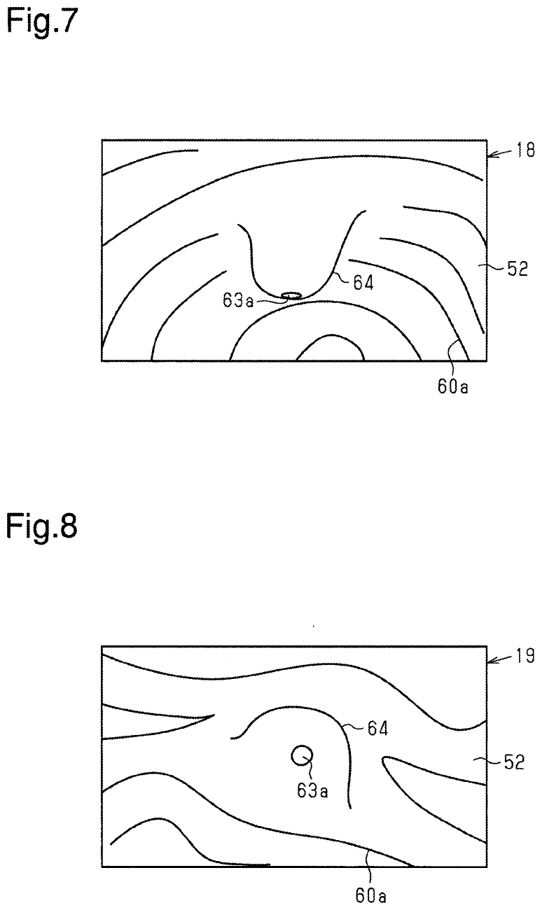

The orientation of the duodenum model 52 may be changed by removing the coupler 46 and rotating the duodenum model 52 or by moving the duodenum model 52 between the first region 44 and the second region 45. When changing the orientation of the duodenum model 52, the orientations of the papilla 64 and the communication hole 63a may change as shown by, for example, a first image 18 of FIG. 7 and a second image 19 of FIG. 8. In this manner, the papilla 64 and the communication hole 63a may be viewed from different angles with the endoscope 12 so that a doctor can be trained to perform a wide variety of manipulations.

The bile duct 61 and the pancreatic duct 62 may be each connected to the transparent tube 14. Thus, when practicing insertion of a guide wire into the bile duct 61 or the pancreatic duct 62, the movement of guide wire through the bile duct 61 or the pancreatic duct 62 may be visual in the tube 14. This allows for easy checking of the training results.

As shown in FIG. 6, the training device 11 may include a holding plate 17 that holds the two tubes 14. The holding plate 17 may include two insertion rings 17a that allow for insertion of the two tubes 14. The holding plate 17 may be placed on the opening surface 32 of the organ model support 30. This holds the tubes 14, the bile duct 61, and the pancreatic duct 62 in an elastically deformable manner even when the tube 14, the bile duct 61, or the pancreatic duct 62 projects out of the opening of the widened portion 39. Thus, the reaction force applied from the human body to the endoscope 12 may be simulated when the endoscope 12 is inserted into the tube 14, the bile duct 61, and the pancreatic duct 62.

At least certain embodiments of the organ models 50, 51, and 52, the organ model support 30, and the training device 11 have one or more of the advantages described below.

(1) The accommodation pit 31 may be formed from an elastic material. Thus, when a doctor inserts the endoscope 12 into the organ models 50, 51, and 52, the doctor will feel the reaction force from the accommodation pit 31. This simulates the manipulation feel of the human body when training a doctor to manipulate an endoscope.

(2) The accommodation pit 31 may include the grooves 35, 36, and 37 that respectively accommodate the organ models 50, 51, and 52. Thus, a doctor can practice manipulating the endoscope 12 through the esophagus and the stomach and into the duodenum.

(3) When the endoscope 12 presses the duodenum model 52, the coupler 46 may be tilted about the portion engaged with the first engagement recess 40a along the second engagement recess 40b as shown by the double-dashed line in FIG. 3. This allows for slight movement of the duodenum model 52. Further, the third groove 37 may be slightly larger than the duodenum model 52. This produces a gap between the duodenum model 52 and the third groove 37 that permits movement of the duodenum model 52.

The elastic deformation and movement of the duodenum model 52 and the elastic deformation of the accommodation pit 31 simulates the feel of the endoscope 12 when the endoscope 12 comes into contact with organs in the human body. As the endoscope 12 moves away from the inner wall of the duodenum model 52, the elastically deformed duodenum model 52 and organ model support 30 return to their original forms, and the coupler 46 returns to its original position.

(4) The accommodation pit 31 of the organ model support 30 may include the engagement recesses 40 near the boundary of the first groove 35 and the second groove 36 and near the boundary of the second groove 36 and the third groove 37. The couplers 46 coupling the organ models 50, 51, and 52 may each engage with the corresponding two engagement recesses 40 to hold the organ models 50, 51, and 52 at the proper positions in the grooves 35, 36, and 37 while permitting elastic deformation of the organ models 50, 51, and 52.

(5) The organ model support 30 includes the projection 41 that projects over the duodenum model 52, which is accommodated in the accommodation pit 31. The projection 41 may keep the duodenum model 52 in the accommodation pit 31. Thus, the duodenum model 52 may not project out of the accommodation pit 31, particularly, the widened portion 39.

(6) The orientation of the duodenum model 52 may be changed by arranging the duodenum model 52 in the first region 44 and in the second region 45. This simulates the different tilts of the duodenal papilla and can be used to train a doctor to perform a wide variety of manipulations. The shape of the duodenum differs between individuals. Thus, by changing the orientation of the duodenum model 52, different shapes of the duodenum can be simulated to train a doctor to perform a wide variety of manipulations.

(7) In the duodenum model 52, the main body 60, the bile duct 61, the pancreatic duct 62, and the duodenal papilla 64 may be formed integrally. For example, if a duodenal papilla member were to be separate from the main body 60, when the duodenal papilla member is attached in a separable manner to the main body 60, a seam would form between the duodenal papilla member and the main body 60. The feel of the endoscope 12 when coming into contact with the seam would greatly differ from that of the human body. In this regard, the duodenal papilla 64 may be formed integrally with the main body 60. This simulates a feel of the human body with the endoscope 12. Accordingly, a feel of the human body is simulated when training a doctor to perform cannulation, guide wire insertion, EST, or stent placement that are techniques related with endoscopic retrograde cholangiopancreatography (ERCP).

(8) The duodenum model 52 may include the annular portion 70 at the location where the bile duct 61 and the pancreatic duct 62 are connected to the main body 60. The annular portion 70 and the portion around the annular portion 70 may be exposed to the outside through the wide opening of the widened portion 39. Thus, sticking marks formed by the wire 13 would be visual and easy to find. Accordingly, the training results can be easily checked.

(9) The duodenal papilla 64 is tilted in the main body 60 toward the second end 69. Thus, an image of the duodenal papilla 64 captured by the endoscope 12 would be close to that of the human body. Further, manipulations performed on the human body can be simulated when training a doctor to perform techniques related with ERCP.

(10) The duodenum model 52 may include the pyloric orifice 66a. Thus, a doctor can be trained to perform the manipulations required to move an endoscope through the pylorus.

(11) The training device 11 can easily be set by placing the organ models 50, 51, and 52 in the accommodation pit 31 through the opening 31b. However, time may be needed to set the training device 11 if the organs surrounding the organ models 50, 51, and 52 are formed and placed separately from the organ models 50, 51, and 52.

(12) The organ models 50, 51, and 52 can be coupled to one another in a separable manner by the couplers 46. Thus, for example, after practicing the manipulations for incising the papilla 64, the used duodenum model 52 can be removed from the stomach model 51 and replaced by a new duodenum model 52. In this manner, each of the organ models 50, 51, and 52 can be easily replaced.

(13) The restraint 16 attached to the duodenum model 52 may be engaged with the first engagement holes 42 to hold the duodenum model 52 in the first region 44. Further, the restraint 16 attached to the duodenum model 52 may be engaged with the second engagement holes 43 to hold the duodenum model 52 in the second region 45. The orientation of the duodenum differs between individuals. Thus, by changing the orientation of the duodenum model 52, a doctor can be trained to perform a wide variety of manipulations. Further, the location of the duodenal papilla differs between individuals. The location and orientation of the papilla 64 can be changed by moving the main body 60. This allows the papilla 64 to be simulated at different locations.

It should be apparent to those skilled in the art that the present disclosure may be embodied in many other specific forms. Particularly, it should be understood that the present disclosure may be embodied in the following forms.

The one or more organ models may include models of other organs such as the pharynx, the large intestine, and the ureter.

The one or more organ models are not limited to models of human body organs and may be models of animal organs.

The organ model support 30 of the above embodiment is not limited to a rectangular parallelepiped, and may be any suitable shape. For example, the organ model support 30 can be shaped like a human body and be accommodated in a case shaped in correspondence with the organ model support 30.

To form an accommodation pit 31 that is further three-dimensional, an organ model support 30 including an accommodation pit 31 shaped in correspondence with the front side of the human body may be joined with an organ model support 30 including an accommodation pit 31 shaped in correspondence with the rear side of the human body with the openings 31b of the two organ model supports 30 joined with each other. In this case, the openings of the grooves 35, 36, and 37 may be covered by an elastic member. This allows for the simulation of a feel that is closer to the human body. The two organ model supports 30 may be, for example, respectively accommodated in the box 21 and the lid 22 of the case 20 so that the training device 11 would be easy to set.

The organ model support 30 does not have to be entirely formed from an elastic material.

The training device 11 may include a model of a head, mouth, or nasal cavity of the human body that serves as an insertion opening for the endoscope 12.

The training device 11 may need only at least one of the organ models 50, 51, and 52.

The present examples and embodiments are to be considered as illustrative and not restrictive, and the disclosure is not to be limited to the details given herein.

It should be understood that one or more of the aspects of any of the embodiments of training devices, organ models, or any other aspects of the present disclosure may be used in combination with any of the other embodiments. It also should also be understood that one or more aspects of any of the embodiments described herein may be used to simulate the body of a human or other animal.

Moreover, while specific exemplary embodiments may have been illustrated and described collectively herein, it should be appreciated that any subsequent arrangement designed to achieve the same or similar purpose may be substituted for the specific embodiments described and shown herein. This disclosure is intended to cover any and all subsequent adaptations or variations of various embodiments. Combinations of the above embodiments, and other embodiments not specifically described herein, will be apparent to those of skill in the art upon reviewing the description.

Other exemplary embodiments of the present disclosure will be apparent to those skilled in the art from consideration of the specification and practice of the exemplary embodiments disclosed herein. It is intended that the specification and examples be considered as exemplary only, and departures in form and detail may be made without departing from the scope and spirit of the present disclosure as defined by the following claims.

1-15. (canceled)

16. A medical training apparatus comprising:
a stomach model;
a duodenum model; and
a first coupler releasably coupling the stomach model to the duodenum model in a first orientation of the duodenum model relative to the stomach model and in a second orientation of the duodenum model relative to the stomach model.

17. The medical training apparatus of claim 16, further comprising:
an esophagus model; and
a second coupler releasably coupling the esophagus model to the stomach model.

18. The medical training apparatus of claim 17, further comprising a partition diaphragm positioned between the esophagus model and the stomach model; and
wherein the duodenum model includes an end wall defining a pyloric orifice.

19. The medical training apparatus of claim 16, wherein the duodenum model includes a main body, a bile duct, a pancreatic duct, and a duodenal papilla projecting into the main body; and
wherein the duodenal papilla has a first position relative to the stomach model when the duodenum model is in the first orientation and has a second position relative to the stomach model when the duodenum model is in the second orientation.

20. The medical training apparatus of claim 19, wherein the main body, the bile duct, the pancreatic duct, and the duodenal papilla are integrally formed.

21. The medical training apparatus of claim 16, further comprising:
an organ model support including an accommodation pit, wherein the accommodation pit is defined by a wall that is curved to conform with outer surfaces of the stomach model and the duodenum model, wherein the accommodation pit comprises elastic material.

22. The medical training apparatus of claim 21, wherein the stomach model and the duodenum model are positioned within the accommodation pit of the organ model support.

23. The medical training apparatus of claim 22, wherein the accommodation pit includes a first engagement recess, and wherein the first coupler is positioned in the first engagement recess.

24. The medical training apparatus of claim 23, wherein the first engagement recess is sized to permit movement of the first coupler therein, and wherein the first coupler is positioned in the first engagement recess so that it moves in the first engagement recess when an endoscope applies a force to the duodenum model.

25. The medical training apparatus of claim 21, wherein a portion of the organ model support overlies a portion of the duodenum model.

26. The medical training apparatus of claim 16, further comprising a second duodenum model, and wherein the first coupler is configured to permit removal of the duodenum model from the stomach model and coupling of the second duodenum model to the stomach model.

27. The medical training apparatus of claim 16, wherein the first coupler includes first and second engagement rings and a hinge pivotally connecting the first engagement ring to the second engagement ring, wherein an end of the stomach model connects to the first engagement ring and an end of the duodenum model connects to the second engagement ring, and wherein the hinge permits the first coupler to close, aligning the ends of the stomach and duodenum models.

28. The medical training apparatus of claim 27, wherein the end of the stomach model includes a flange, wherein the end of the duodenum model includes a flange, and wherein the flange of the end of the stomach model and the flange of the end of the duodenum model are positioned between the first and second engagement rings.

29. A medical training apparatus comprising:
an esophagus model;
a stomach model;
a duodenum model;
a first coupler releasably coupling the stomach model to the duodenum model, a second coupler releasably coupling the esophagus model to the stomach model; and
an organ model support including an accommodation pit for containing the esophagus model, the stomach model, and the duodenum model, wherein the accommodation pit is defined by a wall that is curved to conform with the outer surfaces of the esophagus model, the stomach model, and the duodenum model.

30. The medical training apparatus of claim 29, wherein:
the first coupler includes at least one projection;
the second coupler includes at least one projection;
the organ model support includes a first engagement recess and a second engagement recess;
the first engagement recess is a recess in the pit wall and is configured to receive the at least one projection of the first coupler; and
the second engagement recess is a recess in the pit wall and configured to receive the at least one projection of the second coupler.

31. The medical training apparatus of claim 29, wherein:
the accommodation pit includes a first region and a second region that each allows for arrangement of the duodenum model, and
the duodenum model differs in orientation relative to the stomach model when arranged in the first region and when arranged in the second region.

32. The medical training apparatus of claim 29, wherein the duodenum model includes a main body and a duodenal papilla projecting into the main body;
wherein the duodenal papilla has a first position relative to the stomach model when the duodenum model is in a first orientation and has a second position relative to the stomach model when the duodenum model is in a second orientation; and
wherein the position of the duodenum model in the first orientation is rotated about the first coupler relative to the second orientation.

33. A duodenum model comprising:
a bile duct;
a pancreatic duct;
a tubular main body to which the bile duct and the pancreatic duct are connected, wherein the main body includes a first end with an inlet that allows for entrance of an endoscope and a second end at an opposite side of the first end; and
a duodenal papilla projecting into the main body and tilted toward the second end in the main body,
wherein the main body, the bile duct, the pancreatic duct, and the duodenal papilla are formed integrally with one another.

34. The duodenum model of claim 33, wherein
the main body includes an annular portion surrounding a portion where the bile duct and the pancreatic duct are connected to the main body, and
the annular portion is thicker than other portions of the main body.

35. The duodenum model of claim 33, wherein
the main body includes an end wall closing the first end; and
the end wall includes a pyloric orifice extending through the end wall.
